(19) United States
(12) Patent Application Publication
(10) Pub. No.: US 2017/0290361 A1
(43) Pub. Date: Oct. 12, 2017

(54) Method for Continuously Making Kettle Style Potato Chips

(71) Applicant: Frito-Lay North America, Inc., Plano, TX (US)

(72) Inventors: Ian BAAS, Sunnybank (AU); David Lawrence BARRY, Highland Village, TX (US)

(21) Appl. No.: 15/512,856

(22) PCT Filed: Sep. 26, 2014
(86) PCT No.: PCT/US2014/057591

§ 371 Date: Mar. 21, 2017

(51) Int. Cl. A23L 19/18; A23L 5/10

(52) U.S. Cl. CPC A23L 19/18; A23L 5/11; A23V 2002/00

(57) ABSTRACT

Method for continuously making kettle style potato chips. A continuous cooking process is disclosed without regard or need to mimic the U-shaped temperature-time profile typically used to create kettle-style fried potato chips. Potato slices are placed directly into hot oil of a single continuous fryer having multiple temperature zones, with no flume frying prior to placement therein and without regard to a monolayer arrangement. Cool oil from the end of the continuous fryer to the upstream portion of the fryer ensures continuous achievement of an initial low temperature profile, lower than that of previous methods. A further dip in temperature profile is achieved as water evaporates from the slices. The potato slices are then further fried in the downstream portion of the fryer in one or more regions having increased hot oil temperatures, which occur through the injecting of hot oil into the downstream portions.

### BACKGROUND OF THE INVENTION

### Technical Field

The present invention relates to an improved method for the production of potato chips and more particularly to an economic method for continuously making kettle style potato chips that are similar in taste and texture to those kettle style potato chips produced by a traditional batch process.

### Description of Related Art

Potato chips produced by batch processes in kettle fryers have texture and flavor characteristics that are usually recognized by consumers as being distinctly different from typical commercially produced continuous process potato chips. As the name implies, batch process kettle frying of potato chips involves placing a batch of potato slices in a kettle of hot oil, e.g., at a temperature of about 300-310° F. (about 150-160° C.) and usually takes about 10-13 minutes to complete.

The typical U-shaped time/temperature profile of the cooking oil that has long been associated with the batch-wise production of kettle-style potato chips is illustrated in FIG. 1. Kettle-style potato chips were produced according to the standard U-shaped time/temperature profile exemplified in FIG. 1 in a conventional fry kettle having standard burners and no oil circulation system from potato slices (120 lbs) of between 0.060 and 0.090 inch thickness. Upon introduction of the potato slices into an initial oil temperature of about 310° F. (about 154° C.), the temperature of the oil typically drops quite rapidly by as much as 50° F. (about 28° C.) or more. As depicted by FIG. 1, the oil temperature falls to a low point temperature of about 235° F. to about 240° F. (about 112.7° C. to about 115.6° C.) for a low point time of about 4 minutes. Heat to the kettle is then quickly increased and then the temperature of the oil begins to gradually rise, reaching about the initial frying temperature of about 300° F. (about 148.9° C.). The resultant batch fried potato chip has a moisture content of between 1.5% to 1.8% by weight, and is generally harder and crunchier than typical continuously fried commercial chips. It has long been believed in the art that the U-shaped temperature-time profile is responsible for the unique mouth feel and flavor characteristics of kettle-style potato chips. Thus, continuous methods for the production of kettle-style chips seek to mimic the U-shaped temperature-time profile shown in FIG. 1.

Production rates using batch kettle fryers are dependent upon the equipment used. The modern kettles that are utilized in batch processes are generally manufactured of stainless steel, and vary in size and capacity. The kettles typically are heated by gas burners positioned directly under the kettle floor. Fryer capacities range from as few as 60 pounds per hour to up to 500 pounds per hour (finished product basis), although most batch fry operations have kettle fryers that can manufacture between 150 and 400 pounds of chips per hour. In order to efficiently use a batch kettle fryer of a given size, it is necessary to maintain a particular “load” or amount of potato slices per volume of oil, in order to produce the desired U-shaped temperature-time profile. These and other constraints provide limits on the amount of throughput using batch kettle fryers. By contrast, potato chips made by a continuous process can employ continuous fryers capable of producing 1,000 to 5,000 pounds per hour of finished product. A number of methods have thus been proposed for continuous production of kettle-style potato chips without diminishing the desired hard bite texture and flavor.

U.S. Pat. No. 4,741,912 to Katz discloses a continuous process for frying potato chips having the characteristics of batch type frying, using two or three isothermal frying zones. While a multizone fryer is disclosed as an alternative construction, a series of fryers is used in Katz in order to have separate isothermal temperatures because it is not possible to maintain two or three significantly different isothermal temperature zones in the same body of oil while moving the chips continuously throughout. Moreover, Katz discusses a very tiny temperature drop between frying stages. Because this small temperature drop is not possible in a multizone fryer, Katz uses separate isothermal stages or fryers, each of which having its own pump and its own heat exchanger. These multiple fryers and multiple frying stages slow down the continuous process significantly, add complexity to the system, and increase its costs.

U.S. Pat. No. 7,303,777 discloses a method for continuously making kettle style potato chips by using cooling oil to help achieve the U-shaped temperature-time profile of potato chips cooked in the traditional batch process. FIG. 2 is a schematic representation of the apparatus used for making kettle style potato chips disclosed in U.S. Pat. No. 7,303,777. The apparatus of FIG. 2 includes a slicer 1 for slicing potatoes, which are preferably not washed or rinsed prior to entering hot oil in the flume 5. The potato slices are dropped onto a belt 3 to achieve a monolayer and then fed into the upstream end of the oil flume 5 in a substantially monolayer arrangement to prevent sticking of the potato slices. The slicing onto the belt 3 such that singulated and monolayer slices are presented to the flume ensures minimal clustering and uniform exposure of all slices to the hot oil, thus minimizing potential for soft center formation. Heating oil enters the upstream portion of the flume 5 at the first oil inlet 7 at a flume oil temperature of between about 148° C. (300° F.) and about 160° C. (320° F.). The potato slice is in the flume for a residence time of about 15 to about 20 seconds. The flume 5 may be agitated with agitating means 9, which may include oscillating finger paddles (paddles that travel back-and-forth much like a clock pendulum), rotating finger paddles, drum paddles, dunkers, and/or rotating paddle wheels, to ensure slice separation. The potato slices are next routed to an upstream portion of a fryer 11 where the potato slices achieve a low point temperature of about 230° F. to about 260° F. (about 110° C. to about 126.7° C.) for a low temperature residence time of between about 3 minutes to about 4 minutes. Due to the decreased volume of the flume 5 and the fast flash-off of surface water from the potato slices, the oil temperature rapidly drops to a low point temperature in the upstream portion of the main fryer 11. This is also achieved in part from a hot oil cooler 20 that circulates oil from a single outlet 17 at the end of the first zone of the fryer. The potato slices are then further cooked in the remaining portion of the fryer where the temperature of the hot oil in the fryer increases as the potato slices move further downstream. Paddles 13 may be used to help hold down the product during frying. Various inlets 15 and outlets 17 help control the temperature with the help of a main heat exchanger 19 to mimic the desired U-shape temperature profile of batch-made kettle chips.

A need exists for a more economical apparatus and method for continuously making kettle-style potato chips. The method would further benefit from elimination of the need to mimic the U-shaped temperature time profile thought to be necessary to achieve the desired kettle-style texture and taste.

### SUMMARY OF THE INVENTION

The present invention provides a more cost-effective and space-saving method for continuously making kettle style potato chips that simulates a hard-bite kettle-style potato chip similar to that produced in a traditional batch process. The instant invention, by eliminating the monolayer slicing arrangement and hot oil flume, further eliminates the need for the U-shaped temperature-time profile, which up until now was believed necessary for mimicking the texture and taste of the kettle-style potato chip.

In one embodiment, potato slices are directly placed into a first zone of a single continuous main fryer having multiple frying temperatures but no flume and without regard to any particular mono-layering equipment. Cool oil is drawn from the end of the third zone of the continuous fryer and combined with oil streams exiting from the second zone of the fryer this combined stream of cool oil being then passed through the oil cooler. Thereafter, an additional stream of oil from the end of the first zone of the fryer is combined with the cooled oil from the oil cooler before entering at the most upstream portion of the fryer. In this way, a temperature lower than that previously obtained by prior methods is achieved and which deviates from the typical U-shaped time-temperature profile. By using these cool oil streams the oil cooler requires less cooling water and less energy.

The potato slices thus achieve a low point temperature of about 112° C. (234° F.) to about 118° C. (244° F.) for a low temperature residence time of between about 1 minute to about 3 minutes within the first frying zone. The potato slices are then further cooked in the remaining portion of the fryer where the temperature of the hot oil in the fryer increases as the potato slices move further downstream. Without any flume portion, the present invention provides a more economical apparatus and method for continuously making kettle-style potato chips by a continuous method having desirable hard-bite texture and taste properties.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts the standard temperature profile resulting from the batch-wise production of kettle-style potato chips.

FIG. 2 is a schematic representation of a prior art apparatus used for continuously making kettle style potato chips.

FIG. 3 is a schematic representation of the apparatus used for making kettle style potato chips in one embodiment of the present invention.

FIG. 4 is a graph depicting the temperature profiles resulting from the continuous process depicted in FIG. 2 in contrast to that resulting from the apparatus of FIG. 3.

### DETAILED DESCRIPTION OF THE INVENTION

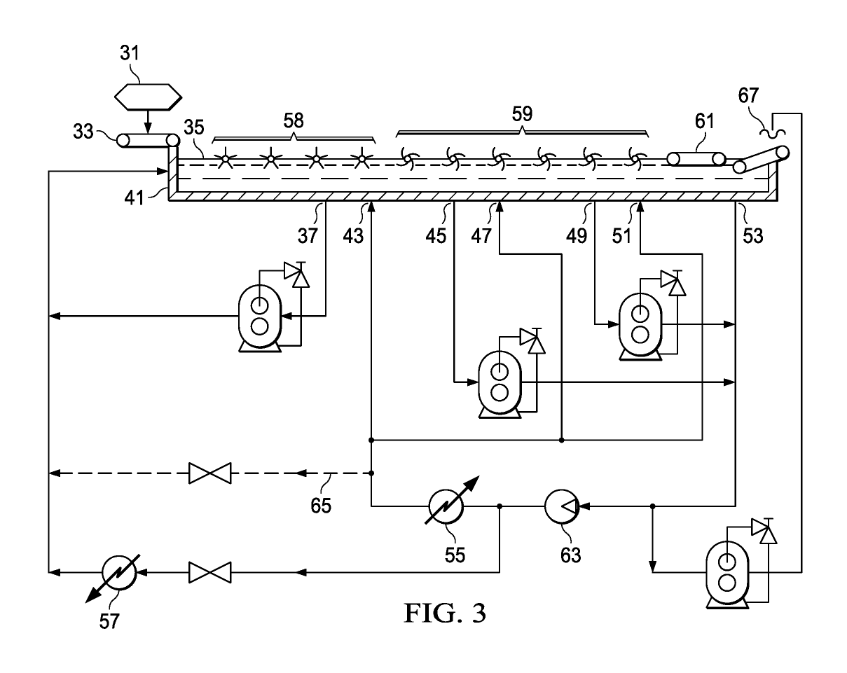

An embodiment of the invention will now be described with reference to FIGS. 3 and 4. The same reference numerals are used to identify the same corresponding elements throughout all drawings unless otherwise noted.

FIG. 3 is a schematic representation of the apparatus used for making kettle style potato chips continuously in a continuous fryer without a flume in one embodiment of the present invention. The apparatus includes a slicer 31 for slicing peeled potatoes. By way of example, the potatoes may be sliced to a thickness of between about 0.058 inches (1.47 mm) to about 0.064 inches (1.63mm) using an Urschel variable thickness slicer 31. The slices are unwashed (i.e., not rinsed) prior to entering into the main fryer in one embodiment; however, the slices may also be washed in another embodiment. The potato slices are then dropped onto a belt or vibratory pan 33 without regard to monolayer arrangement. That is, a plurality of potato slices are dropped onto the belt or vibratory pan 33 in an unorganized or random arrangement after slicing, and then transferred directly into a main fryer 35 with no flume portion. As used herein, the terms “main fryer,” “fryer,” or “continuous fryer” are used interchangeably and are meant to refer to a single, continuous, multizone fryer having a consistent and single depth and no flume. In one embodiment, the single oil depth of the continuous multizone fryer is about 180 mm, or about 7.1 inches.

The main fryer comprises at least three different zones of temperature within the fryer. At introductory of the slices, the continuous fryer comprises a first zone having rotating and reversing finger paddles 58 with an initial oil temperature of between about 135° C. and about 148° C. (about 275° F. and about 298.4° F.). In one embodiment, the initial oil temperature is about 139° C. (282.2° F.). To maintain the temperature profile of the first zone, portions of cool zone outlet oil from the main fryer are circulated through oil pump 63 and directed through a cooling heat exchanger or oil cooler 57. More specifically, as depicted in FIG. 3, oil removed from outlets 45, 49, 53 are combined and directed to pump 63 prior to further cooling through the oil cooler 57. The cooled oil is then mixed with oil removed from the first outlet 37 of the fryer with the resulting mix being then injected into the first oil inlet 41 of the fryer. Oil from the first outlet 37 helps further cool the oil in light of the decreased temperature at 37, which is due to product load. In one embodiment, the oil from the pump 63 enters the oil cooler 57 at a temperature between about 135° C. (275° F.) and about 145° C. (293° F.). After mixing with the oil from outlet 37, the oil is injected into the first inlet 41 at a temperature of between about 130° C. 266° F.) and about 140° C. (284° F.). Varied textures can be produced by either additional cooling to make the product harder or through addition of heating oil to the mix. Thus, optionally, heating oil may come from the heater 55 or from a supplemental heat exchanger. In one embodiment, the heating oil may enter the mix at a temperature of between about 165° C. (329° F.) and about 175° C. (347° F.). Potato slices remain in the first zone of the fryer, defined as the initial temperature drop area in the fryer until the first outlet 37 of the fryer, or the upstream portion of the fryer, for at least 1 minute but no more than 4 minutes before passing into a second zone of the fryer. In one embodiment, the frying time within the first zone is between about 1 to about 3 minutes before passing into a second zone of the main fryer. In one embodiment, the frying time of the first zone may be between about 90 to about 120 seconds. At the exit or end of the first zone, the main fryer comprises a first zone exit oil temperature of between about 110° C. (230° F.) and about 122° C. (251.6° F.). In one embodiment, the first zone exit oil temperature is between about 114° C. (237.2° F.) and about 122° C. (251.6° F.). In one embodiment, the first zone exit oil temperature is about 116° C. (240.8° F.).

As used herein, the second zone of the main fryer 35 is defined as the general area between the second inlet 43 and the third outlet 49. The second zone comprises paddles to continuously convey the slices through the second zone and to the third zone, which is beneath a hold down conveyor, further described below. Any type of paddles or rotating wheels or dunkers 59 can be used to continuously convey the slices through the main fryer 35. The heated hot oil of the second zone is within a temperature range of about 130° C. (266° F.) to about 150° C. (302° F.). This second zone temperature is controlled within the desired range by both removal of a portion of cool oil and by injecting heated oil into the second zone downstream from the first zone at a temperature of about 160° C. (320° F.) to about 180° C. (356° F.). After entering the second zone, potato slices will be conveyed throughout this zone and remain therein for about 2 to about 4 minutes before passing downstream to a third zone of the continuous fryer.

A hold-down conveyor or submerger 61 can help submerge and convey potato slices throughout a third zone of re-heated hot oil as the potato slices are dehydrated to a moisture content of less than about 2% and more preferably less than about 1.5%. The speed of the paddles 59 or submerging conveyor 61 can be varied to increase or decrease the dwell time of the potato slices in the fryer. Both the submerging conveyor 61 speed and the inlet temperature 51 may be automatically varied by smart controls software to achieve an outlet moisture content of about 1.5%, for example. To achieve the desired moisture content, a portion of the cool oil is removed at the end of the second zone and heated oil at a temperature of about 160° C. (320° F.) to about 180° C. (356° F.) is injected into the third zone to achieve a zone temperature of between about 140° C. (284° F.) and about 160° C. (320° F.). At the end of the third zone, an endless take out conveyor removes the finish-fried potato chips from the fryer 35. The total dwell time of the potato slices after exiting the slicer 31 to their removal from the main fryer 35 is between about 7 to about 9 minutes. In one embodiment, the total dwell time is between about 7 to about 8 minutes. In one embodiment, the total dwell time is about 7 minutes. In one embodiment, the total dwell time is about 8 minutes. In one embodiment, the total dwell time is about 9 minutes. The oil content of the potato chips made by the above-described process is between about 20% to about 25% by weight, which can be lower than a kettle-style chip made in a traditional process. If desired, oil may be added to the chips upon exit to mimic the typical oil content in a traditional kettle-style potato chip. In one embodiment, an oil curtain is added prior to measurement of the potato slice moisture content.

Thus, as shown above, the method for continuously making kettle style potato chips in a continuous fryer with no flume comprises the steps of: placing a plurality of potato slices directly after slicing into an upstream portion of a first zone of the continuous fryer at an initial oil temperature of between about 135° C. (275° F.) and about 150° C. (302° F.); frying the potato slices in said first zone for between about 1 to about 3 minutes before passing into a second zone of the continuous fryer, wherein the first zone comprises a first zone exit oil temperature of between about 110° C. (230° F.) and about 122° C. (251.6° F.); removing a portion of cool oil from and injecting heated oil into the second zone downstream from the first zone of the continuous fryer and frying the potato slices within the second zone at a second zone temperature of between about 130° C. (266° F.) to about 150° C. (302° F.) for about 2 to about 4 minutes before the potato slices pass downstream from the second zone into a third zone of the continuous fryer; and removing a portion of cool oil from and injecting heated oil into the third zone downstream from the second zone and frying the potato slices in the third zone at a third zone temperature of between about 140° C. (284° F.) to about 160° C. (320° F.) under a submerger until a potato slice exit moisture content of about 1.0% to about 2.0% is achieved. The heated oil injected into the second and third zone may comprise a temperature of from about 160° C. (320° F.) to about 180° C. (356° F.). Table 1 below illustrates certain embodiments that may be used to produce specific textures.

TABLE 1
Texture Resulting from different oil temperatures and frying times

| | Inlet oil | Cold zone oil | Outlet oil | Total Dwell |
|---|---|---|---|---|
| Kettle | temperature | temperature | temperature | Time in Fryer |
| Texture | (° C.) | (° C.) | (° C.) | (min) |
| Softer | 145-148 | 120-122 | 144-148 | 7.0-7.5 |
| Standard | 138-140 | 115-117 | 142-146 | 8.0-9.0 |
| Harder | 134-138 | 114-116 | 142-146 | 10.0-11.0 |

In continuously producing the hard-bite kettle-style potato chip in the multizone fryer, a low point temperature and a low temperature residence time must be achieved. As used herein, low temperature residence time is defined as the approximate amount of time it takes a potato slice to travel from the first zone of the main fryer to the approximate location in the fryer where the fryer oil temperature begins to increase, generally at entry to the second inlet 43. As used herein, the low point temperature is defined as the temperature range that is within about 10° C. (18° F.) of the lowest oil temperature measured in the first zone of the fryer, which is about 110° C. (230° F.) to about 120° C. (248° F.). The low point temperature and low temperature residence time can be better controlled particularly with changing mass rate of slices by controlling the oil temperature into the inlet 41 through the use of the oil cooler 57.

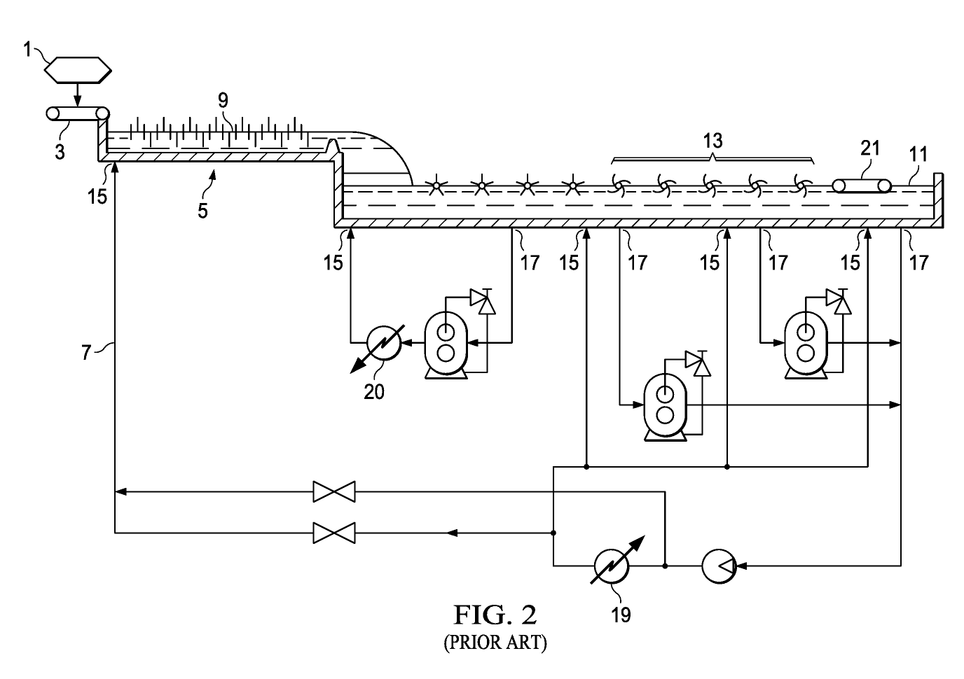

FIG. 4 depicts the temperature profile of both the prior art method of FIG. 2 and the improved method described herein in relation to FIG. 3. The water evaporating from the slices provides the final dip in the curve of the improved method described herein. As depicted in FIG. 4, the dip for the improved method is less than the prior art version and it is clear the improved version starts at a much lower temperature than previously thought necessary. The oil from the oil cooler allows precise control of the bottom of the temperature curve as the product evaporation cooling is variable with the load of potato slices, and amount of water in the potato slices.

Heat throughout the continuous main fryer 35 can be controlled with a number of outlets and inlets throughout the main fryer 35, which help circulate the frying oil therein through heating oil and cooling oil exchangers. In one embodiment, hot oil from pump 63 is cooled in a oil cooler 57 to a temperature of between about 135° C. (275° F.) to about 145° C. (293° F.) before being blended with oil from outlet 37 and routed to a first inlet 41 in the upstream portion of the fryer, or the beginning of the first frying zone. In one embodiment, the hot oil exits the oil cooler 57 at 600 liters/minute. The optimal temperature or temperature range of cooled oil exiting the oil cooler 57 and being blended prior to entering the first inlet 41 can be determined based upon product flow (e.g., kilograms per hour of potato slices in the fryer) and oil from the first outlet 37. Use of an oil cooler 57 enables the potato slices to achieve a low point temperature of between about 110° C. (230° F.) to about 120° C. (248° F.) for a low temperature residence time of between about 1-3 minutes in the first frying zone. The oil cooler 57 can use cooling water or any other desirable fluid as the cooling medium. The cool oil from the oil cooler 57 can ensure that the desired low point temperature is reached for the desired low temperature residence time before heated oil is added to elevate the temperature in the main fryer to further dehydrate the potato slices.

Once the potato slices have reached the desired low point temperature for the desired low temperature residence time, the oil in the remaining portion of the fryer 35 is re-heated to finish fry the slices to a moisture content of about 1-2%. Thus, the temperature in the remaining portion 35 of the fryer increases as the potato slices move downstream. As used herein, the remaining portion of the fryer 35 includes the second and third zones and is defined as the area generally downstream of the second inlet 43. This re-heating can be efficiently achieved by draining a portion of the cooler fryer oil through a plurality of oil outlets 45, 49, 53 while also adding heated hot oil to the fryer through a plurality of inlets 43, 47, 51. In one embodiment, oil inlets are placed downstream of oil outlets to remove a portion of cooled oil and introduce hot oil such that the new fryer temperature will increase. Removal of cool oil lessens the total oil volume that is re-heated. While FIG. 3 depicts only several inlets and outlets, it should be noted that additional inlets and/or outlets can be used to control the temperature of the cooking oil as recognizable to those skilled in the art. Further, the inlet temperatures can be varied by manipulating the outlet temperatures of the heat exchangers, including the main heat exchanger 55, the cooling heat exchanger 57, and any optional trim heat exchanger, for example. In one embodiment, the main heat exchanger 55 and any optional trim heat exchanger (not depicted) may use steam as a heating medium. In one embodiment, a gas heating exchanger may be used as a heating medium. In one embodiment, the main heat exchanger 55 has an exit oil temperature of between about 170° C. to about 190° C. (about 338° F. to about 374° F.). Such a temperature can increase the driving force to better enable the reheating of the oil in the fryer subsequent to the low point temperature. The inlet oil temperatures can also be controlled by mixing cooling oil including, but not limited, to, fresh oil at ambient temperatures, oil exiting the oil cooler 57, or from a by-pass line that by-passes the heat exchanger 55 with the heated oil exiting the heat exchanger 55. The potato slices are dehydrated to a potato slice exit moisture content of below 2%, and more preferably below about 1.5% by weight. As used herein, the potato slice exit moisture content is defined as the moisture content of the potato slices after exiting the fryer. Optionally, at least one of the oil inlet 43, 47, 51 temperatures are adjusted based upon the outlet moisture content of the potato slices as measured by a moisture measuring device situated in proximity of an outlet endless conveyor belt, similar to that depicted in FIG. 2. A model FL710, available from NDC Infrared Engineering, of Irwindale, Calif. can be used for a moisture measuring device. Similar to the apparatus of FIG. 2, the oil flow, oil temperature, and submerger speed can be varied, either independently or in combination, to control the potato slice exit moisture content.

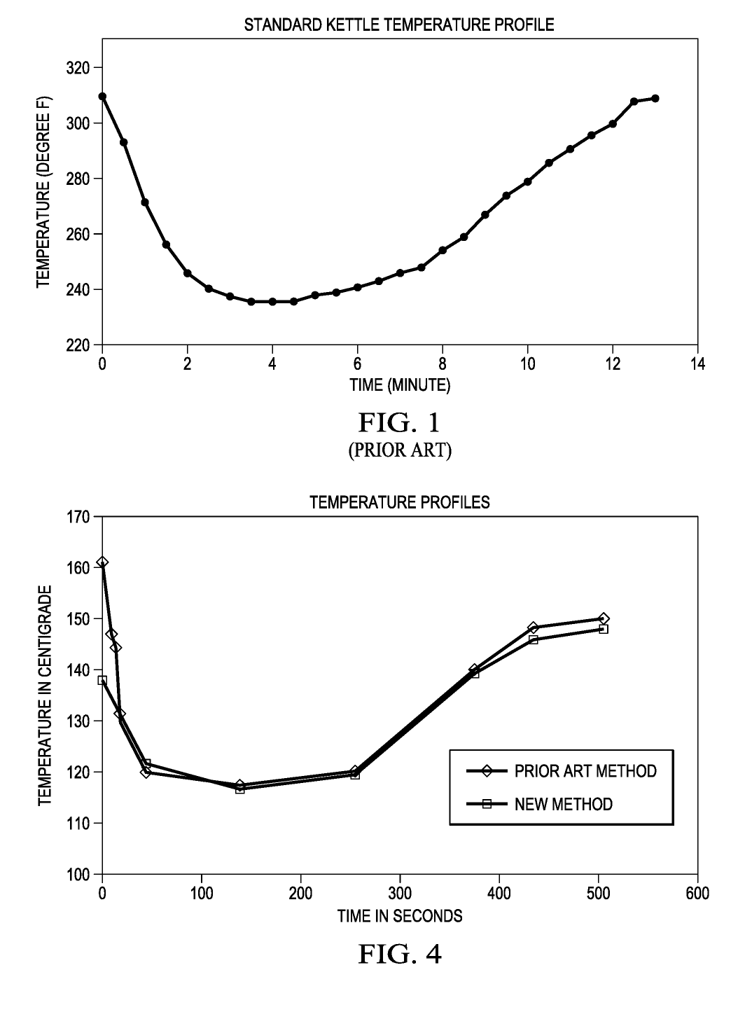

Prior to this discovery, it was believed that a typical U-shaped temperature profile such as that of FIG. 1 was necessary to achieve desirable kettle-style potato chips. FIG. 4, however, depicts that the temperature profile of the improved continuous kettle fry process of the present invention mimics more of a J-curve, starting at a lower temperature without the frying step through a flume and in random order; that is, without regard for the monolayer arrangement. As shown in FIG. 4, the prior art process mimics the U-shaped profile of FIG. 1. This was achieved with the aid of the flume portion of the fryer together with the organized single layer arrangement of slices. A monolayer arrangement also helped minimize clusters and was believed necessary to avoid soft centers and ensure thorough frying in the finished product for shelf stability. However, using the present apparatus and method, the temperature profile no longer needs to mimic the U-shape; rather it is more of a J-shape used to arrive at a similar batch-style kettle chips. One advantage of the present invention is that an expensive flume design or monolayer arrangement is no longer necessary, saving time, space, and costs while arriving at the same desirable product. Less heat is also required due to the absence of a flume. In addition, the arrangement wherein the oil cooler 57 is used with combined portions of oil removed throughout the fryer requires less cooling water and provides for energy reduction.

The following is a specific example of one embodiment of the invention. Approximately 1800 kg per hour of unwashed sliced potatoes (corresponding to approximately 500 kg per hour of finished product) were sliced to a thickness of about 1.55 mm onto a flat wire belt and then dropped directly into the main fryer. Hot oil from the fryer outlet at about 145° C. (293° F.) was cooled and combined with oil from the first outlet 37 to provide a total flow of 930 liters per minute at a temperature of about 141° C. (286° F.) that was then pumped into the main fryer inlet. The potato slices were conveyed through the first zone and agitated by rotating finger paddles that ran in both forwards and backwards directions in the first zone. The potato slices had a residence time of approximately 90 to 120 seconds in the first zone with an oil temperature at the exit of the first zone of about 114° C. (237° F.). The potato slices then fed into the second zone of the main fryer where about 320 liters per minute of hot oil from the heat exchanger at about 184° C. (363.2° F.) was added to the main fryer. About halfway through the second zone, about 235 liters per minute of oil was removed from the main fryer and about 360 liters per minute of hot oil from the heat exchanger at about 175° C. (347° F.) was added to the main fryer. At the end of the second zone, about 215 liters per minute of oil was removed from the main fryer and about 260 liters per minute of hot oil from the heat exchanger at about 175° C. (347° F.) was added to the main fryer. The potato slices were controlled and dunked by standard rotating paddles similar to those found in regular potato chip fryers as they were conveyed for about 2 to 2.5 minutes through the second zone. The potato slices then fed into the third zone of the main fryer where they were submerged in the oil by a hold down belt (sometimes referred to as a submerger) for between 3 to 4 minutes. The finished potato chips exited the third zone onto a wire mesh conveyor that removed them from the main fryer while the oil at the end of the main fryer exits at about 145° C. (293° F.) to a fines removal device from which a portion is sent to the oil cooler and a portion is sent to the oil heater. About 500 kg per hour of finished potato chip product having kettle-style taste and texture was achieved. The resultant finished potato chip product had a moisture content of about 1.5 percent by weight and an oil content of about 23% to 24% by weight. The resultant finished potato chip product was evaluated by an expert panel to have typical kettle chip flavor, texture and appearance.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. The invention can be practiced in the absence of any additional steps or limitations not disclosed or referenced herein. Moreover, any combination of the above-described elements in all possible variations thereof is encompassed by the invention unless otherwise indicated herein or otherwise clearly contradicted by context.

We claim:

1. A method for continuously making kettle style potato chips in a continuous fryer with no flume comprising the steps of:
a) placing a plurality of potato slices directly after slicing into an upstream portion of a first zone of the continuous fryer at an initial oil temperature of between about 135° C. and about 148° C., wherein an oil cooler draws oil from multiple outlets throughout the fryer to control the first zone temperature;
b) frying the potato slices in said first zone for between about 1 to about 3 minutes before passing into a second zone of the continuous fryer, wherein the first zone comprises a first zone exit oil temperature of between about 110° C. and about 122° C.;
c) injecting heated oil into the second zone downstream from the first zone of the continuous fryer and frying the potato slices within the second zone at a second zone temperature of between about 130° C. to about 150° C. for about 2 to about 4 minutes before the potato slices pass downstream from the second zone into a third zone of the continuous fryer; and
d) injecting heated oil into the third zone downstream from the second zone and frying the potato slices in the third zone under a submerger at a temperature of between about 140° C. to about 160° C. until a potato slice exit moisture content of about 1.0% to about 2.0% is achieved.

2. The method in claim 1 wherein the heating oil of the third zone exits the main fryer at a third zone exit temperature of between about 145° C. and 150° C.

3. The method in claim 1 comprising a second zone temperature of about 140° C.

4. The method of claim 1 wherein the oil cooler draws oil from a downstream end of the third zone and an outlet of the second zone to make a combined cooled oil and wherein the combined cooled oil is combined with an oil stream from a downstream end of an outlet of the first zone before being injection back into the upstream portion of the first zone.

5. The method of claim 4 wherein the oil cooler draws oil from a second outlet of the second zone to make the combined cooled oil prior to combination with the oil stream from the downstream end of the outlet of the first zone.

6. The method of claim 1 wherein the initial oil temperature of the first zone results from a combination of hot oil from a fryer outlet of the main fryer and hot oil from a heat exchanger.

7. The method of claim 1 wherein the initial oil temperature of the first zone is about 139° C.

8. The method in claim 1 wherein the first zone exit oil temperature is between about 114° C. and about 122° C.

9. The method in claim 1 wherein the first zone exit oil temperature is about 116° C.

10. The method of claim 1 wherein the potato slices are fried in the first zone for a period of time from between about 1 to about 1.5 minutes.

11. The method of claim 1 wherein oil is removed from an exit port of the second zone and hot oil is introduced along an entry port in the second zone of the continuous fryer.

12. The method of claim 1 wherein the potato slices fry within the second zone for between about 2 to about 2.5 minutes.

13. The method of claim 1 wherein the potato slices fry within the third zone for between about 1.5 to about 4.0 minutes.

14. The method of claim 1 wherein the potato slices fry within the third zone for between about 1.5 minutes to about 2.5 minutes.

15. The method of claim 1 wherein the total dwell time of the potato slices in the continuous fryer is about 7.0 minutes.

16. The method of claim 1 wherein the total dwell time of the potato slices in the continuous fryer is about 8.0 minutes.

17. The method of claim 1 wherein the total dwell time of the potato slices in the continuous fryer is about 9.0 minutes.

18. The method of claim 1 wherein the total dwell time of the potato slices in the continuous fryer is about 10.0 to about 11.0 minutes.

19. The method of claim 1 wherein a potato slice exit moisture content of about 1.5% is achieved.

20. A snack food potato chip made by the method of claim 1.
